(19) United States
(12) Patent Application Publication
(10) Pub. No.: US 2004/0164579 A1
(43) Pub. Date: Aug. 26, 2004

(54) Automotive trunk hauling liner

(76) Inventor: Earnest J. Sims JR., Depew, NY (US)

Correspondence Address: Earnest J. Sims, Jr., 46 Brunswick Road, Depew, NY, 14043, US

(21) Appl. No.: 10/614,893

(22) Filed: Jul. 9, 2003

Related U.S. Application Data
(60) Provisional application No. 60/394,248, filed on Jul. 9, 2002.

(51) Int. Cl. B60R 13/01

(52) U.S. Cl. 296/39.1

(57) ABSTRACT

A protective lining used for protecting the finished surfaces of the cargo carrying area of a vehicle. The lining is formed of a puncture resistant protective sheet generally formed in the shape of the cargo carrying space. Fastening devices around the periphery of the sheet are used to attach and hold in place the sheet to the cargo carrying space.

### REFERENCE TO RELATED APPLICATION

The present application claims priority to Provisional Application Serial No. 60/394,248 filed Jul. 9, 2002 and entitled “Trunk Liner.”

### BACKGROUND OF THE INVENTION

The present invention generally relates to the field of automotive accessories, and more particularly is directed to a liner which can be used to line the interior of the cargo space of a vehicle as a protective shield from damage.

Since the beginning of motorized travel, cars and trucks have played an important role not only in transporting passengers, but in carrying cargo as well. Automobiles, such as sedans and the like, were originally designed to carry passengers and trucks were designed to carry cargo. However, trends in consumer preferences in recent years, together with rising cost, have forced compromised choices to be made. In today's world, automotive vehicles are very expensive and owners cannot always afford to have both an automobile for passenger travel and a truck for carrying cargo. In many cases one-vehicle owners must use them for both purposes, thus more rapidly increasing their wear and tear.

Vehicle owners also are eager to reserve as much equity as possible for resale and trade in-value. Most vehicles are used for a variety of activities such as carrying groceries, garden supplies, building materials, such as lumber, and a host of other items. Many times, these items are carried in the truck space of the vehicle. Most trunk spaces come from the manufacture with some form of liner that over time, depending on the items being carried, can become damaged and worn. Thus the resale and trade in-value will be adversely affected.

Accordingly, there is a need in the art for a way of providing a secondary lining for the trunk in order to reduce the amount of wear and tear on the original lining.

### SUMMAY OF THE INVENTION

Accordingly, it is the overall objective of the present invention to provide a vehicle trunk liner in order to reduce the amount of wear and tear on the original trunk lining.

It is a specific objective of the present invention to provide a vehicle trunk liner which is easy and economical to install in existing vehicle trunk space.

It is another specific objective of the present inventions to provide a vehicle trunk liner which is light in weight while at the same time being durable and resistant to tearing and puncture by objects placed in the trunk.

It is a further specific objective of the present invention to provide a vehicle trunk liner that can be easily removed and reinstalled.

It is a still further specific objective of the present invention to provide a vehicle trunk liner that does not interfere with the normal operation of the trunk for carrying cargo.

It is another specific objective of the present invention to provide a vehicle trunk liner that does not restrict the amount cargo carrying space in the trunk.

### BRIEF DESCRIPTION OF THE DRAWINGS

The novel features of the present invention are set out with particularity in the appended claims. The invention will be understood more fully and clearly from the following detailed description of the invention as set forth in the accompanying drawings in which:

FIGS. 1 and 2 illustrates the trunk space in a typical vehicle the trunk liner of Applicants invention; and

FIG. 3 illustrates a Velcro component used for attaching the trunk liner of Applicant's invention to the interior of a trunk.

### DESCRIPTION OF THE PREFERRED EMBODIMENT

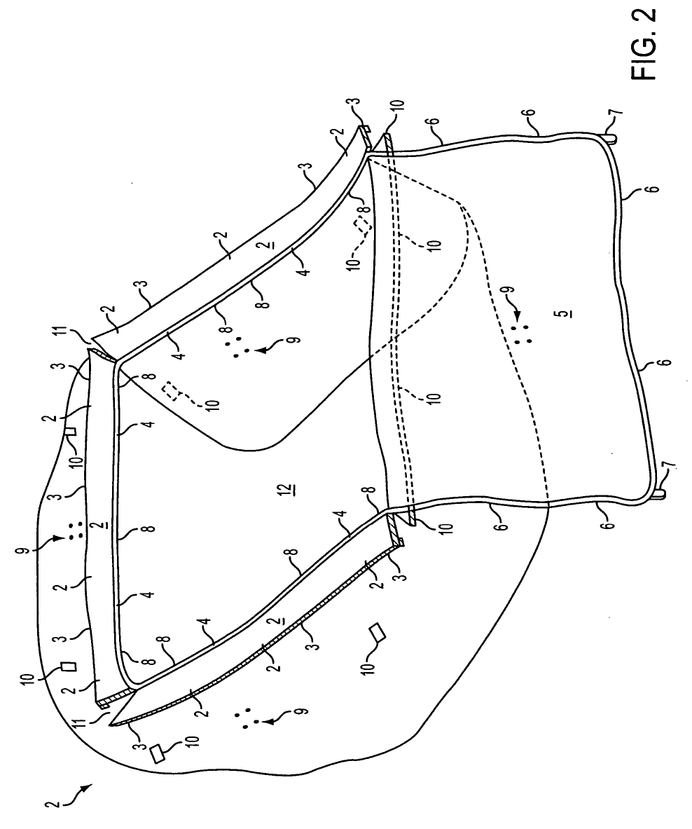

In order to help prevent damage to the cargo carrying areas of cars and trucks, Applicant has designed a trunk liner as illustrated in FIG. 2. The liner can be a valuable commodity for all automotive vehicle owners. This liner is also a very economical product and is practical to use. It can be produced at reasonable cost from a number of inexpensive materials and in almost any color and size with degradable and recyclable products such as plastics, paper cardboard and other such material.

The liner can be installed by most any-one in a matter of minutes. The liner may be installed with a variety of different items such as Velcro, clamps, adhesive tapes, magnets, buttons, buckles, zippers, snaps, cable, string, ropes, hooks, metal or other material even pins. It can also be installed with frames that fit in the trunk made of plastic, metal, wood or other materials. Also, this liner can be designed to fit the contour of a vehicle trunk or oval style, one size fits all according to style of vehicle. If the liner becomes tattered it can be disposed of along with other rubbish and easily replaced.

The invention can be readily understood from the attached drawing.

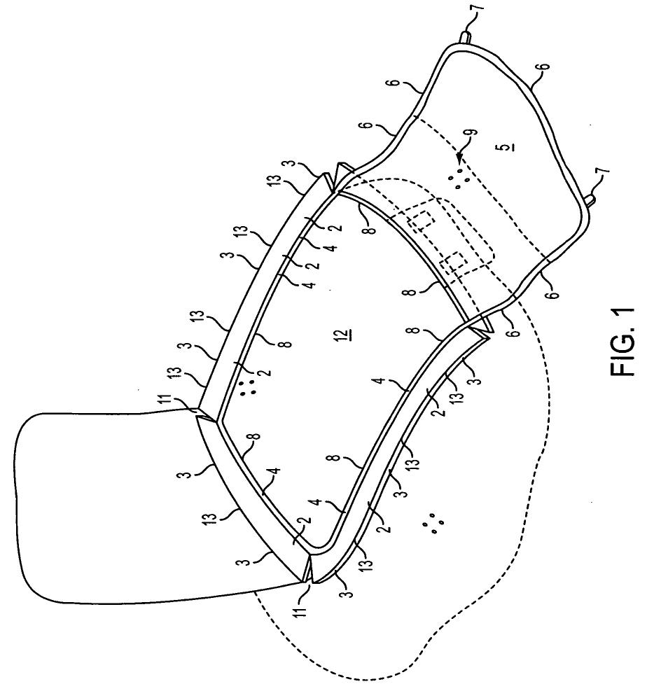

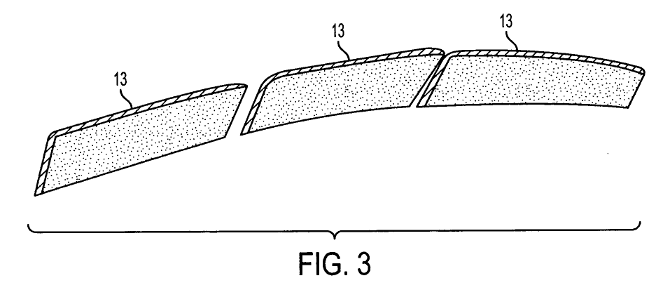

As shown in FIGS. 1 and 2, reference No. 1 illustrates Applicant's trunk liner open for installation. Reference No. 2 illustrates an anchor collar around the mouth of the liner. Reference No. 3, illustrated in FIG. 3, shows a Velcro component on the outer edge of the collar which attaches to the anchor around the inside of the vehicle. Reference No. 4 illustrates a Velcro lid fastener around the mouth of the liner as better shown in FIG. 3. Reference No. 5 illustrates the liner lid and Reference No. 6 illustrates the Velcro faster on the lid. Reference No. 7 illustrates a plurality of tabs used to open and faster the lid. Reference No. 8 illustrates the mouth of the liner in accordance with the present invention. Reference No. 9 show a plurality of perforated air holes around the liner and Reference No. 10 illustrate a plurality of stabilizer anchors around the liner. Reference No. 11 refer to a portion of the liner which contains openings in order to accommodated the trunk lid hinges. Reference No. 12 notes the bottom of the liner and Reference No. 13 illustrates Velcro anchoring for a vehicle bed frame.

It should be obvious from the above-discussed embodiment of the present invention that numerous other variation and modifications of the invention are possible, and such will readily occur to those skilled in the art. Accordingly, the scope of the invention is not to be limited to the embodiment disclosed, but is to include any such embodiments as may be encompassed within the scope of the claim as appended hereto.

I claim:

1. A protective lining for the cargo carrying area of a vehicle, said lining comprising:
a protective sheet generally formed in the shape of said cargo carrying space, said sheet being made of a puncture resistant material; and
at least one fastening device for fastening said protective sheet to said cargo carrying space.

2. A protective lining according to claim 1, wherein said protective sheet is formed of a plastic material.

3. A protective lining according to claim 1, wherein said protective sheet is formed of a canvas material.

4. A protective lining according to claim 1, wherein said protective sheet is formed of a material impervious to water.

5. A protective lining according to claim 1, wherein said protective sheet is formed of a material impervious to oil and oil-like substances.

6. A protective lining according to claim 1, wherein a plurality of said fastening devices are provided around the periphery of said protective sheet for fastening said protective sheet to said cargo carrying space.

7. A protective lining according to claim 6, wherein said fastening devices are formed of Velcro.

8. A protective lining according to claim 6, wherein said fastening devices are formed of adhesive tape strips.

9. A protective lining according to claim 6, wherein said fastening devices are formed string ties.
